(19) United States
(12) Patent Application Publication
(10) Pub. No.: US 2018/0252233 A1
(43) Pub. Date: Sep. 6, 2018

(54) TURBO COMPRESSOR AND TURBO CHILLING APPARATUS EQUIPPED WITH THE TURBO COMPRESSOR

(71) Applicant: MITSUBISHI HEAVY INDUSTRIES THERMAL SYSTEMS, LTD., Tokyo (JP)

(72) Inventors: Ryosuke SUEMITSU, Tokyo (JP); Yasushi HASEGAWA, Tokyo (JP); Noriyuki MATSUKURA, Tokyo (JP); Shintaro OMURA, Tokyo (JP)

(73) Assignee: MITSUBISHI HEAVY INDUSTRIES THERMAL SYSTEMS, LTD., Tokyo (JP)

(21) Appl. No.: 15/756,622

(22) PCT Filed: Jan. 12, 2017
(86) PCT No.: PCT/JP2017/000789

§ 371 Date: Mar. 1, 2018

(30) Foreign Application Priority Data
Jan. 13, 2016 (JP) 2016-004372

(51) Int. Cl. F04D 29/58; F04D 29/056; F04D 29/62; F25B 1/053; F04D 29/052

(52) U.S. Cl. CPC F04D 29/5806; F04D 29/056; F16C 19/163; F25B 1/053; F04D 29/052; F04D 29/62

(57) ABSTRACT

The object of the present invention is to suppress a mechanical loss caused by thermal elongation or rotational vibration of a rotary shaft of a turbo compressor for compressing a low pressure refrigerant used at a maximum pressure of less than 0.2 MPaG so as to enhance the efficiency of a turbo chilling apparatus. The turbo compressor is a turbo compressor for compressing a low pressure refrigerant used at a maximum pressure of less than 0.2 MPaG, the turbo compressor including: a rotary shaft; an electric motor coaxially disposed on an intermediate portion of the rotary shaft so a to rotationally drive the rotary shat impellers fixed to one end of the rotary shaft and forming a compression portion; a first bearing pivotally sporting the rotary shaft between the electric motor and the impellers; and a second bearing pivotally supporting the other end of the rotary shaft, wherein the first bearing is formed of a rolling bearing, and the second bearing is formed of a sliding bearing.

### TECHNICAL FIELD

The present invention relates to a turbo compressor for compressing a low pressure refrigerant, and a turbo chilling apparatus equipped with the turbo compressor.

### BACKGROUND ART

As is well known, a turbo chilling apparatus used as a heat source for district heating and cooling, for example, includes a turbo compressor of a centrifugal turbine type which is driven by an electric motor. An HFC (Hydro-Fluoro-Carbon) refrigerant which is conventionally used in a turbo chilling apparatus has a GWP (Global Warming Potential) of several hundred or more to several thousand or less. Accordingly, changing over from an HFC to an HFO (Hydro-Fluoro-Olefin) refrigerant having a GWP of less than ten is an urgent task.

For example, a low pressure refrigerant used at a maximum pressure of less than 0.2 MPaG, such as HFO-1233zd (E), has a characteristic that a gas specific volume is large compared to a conventional high pressure refrigerant such as HFC-134a. Accordingly, when such a low pressure refrigerant is used as a chiller refrigerant, a refrigerant gas density at a suction port of a turbo compressor is reduced to approximately one fifth. For this reason, to allow the low pressure refrigerant to exhibit substantially the same chilling capacity as the high pressure refrigerant, it is necessary to increase an impeller diameter of the turbo compressor.

Also to allow a chilling device having the same shape to be operated within a wide chilling capacity range, it is desirable to design a large impeller diameter. When the impeller diameter is increased, a shaft rotational speed which satisfies a required peripheral speed of an impeller is lowered. Accordingly, as in the case of a turbo compressor disclosed in PTL 1, an electric motor and impellers can be coaxially driven without using a step-up gear. As a result, it becomes unnecessary to lubricate the step-up gear so that a structure of the turbo compressor can be simplified.

### CITATION LIST

### Patent Literature

{PTL 1} the Publication of Japanese Patent No. 3716061

### SUMMARY OF INVENTION

### Technical Problem

However, due to the increase in impeller diameter, an overhanging weight of an end portion of a rotary shaft on a side where the impellers are mounted becomes large so that a natural frequency of the rotary shaft is lowered (a Q value is increased) and hence, it becomes difficult to avoid resonance within a required rotational speed range. Accordingly, rotational vibration may occur. For this reason, there is a concern that the generation of rotational vibration causes a mechanical loss thus lowering the efficiency of a turbo chilling apparatus or causing a breakage of the rotary shaft.

To compress a low pressure refrigerant having a low gas density, it is necessary to largely increase a rotational speed of an electric motor (for example, from 60 Hz to 200 Hz). Due to such rotation of the electric motor at a high speed and the lowering of cooling performance of the electric motor caused by the lowering of a refrigerant gas density, an amount of heat input from the electric motor to the rotary shaft is increased. Accordingly, an amount of thermal elongation of a rotary shaft is increased so that the above-mentioned mechanical loss and rotational vibration may be exacerbated.

The present invention has been made under such circumstances, and it is an object of the present invention to provide a turbo compressor for compressing a low pressure refrigerant used at a maximum pressure of less than 0.2 MPaG, wherein a mechanical loss caused by thermal elongation or rotational vibration of a rotary shaft can be suppressed thus enhancing the efficiency of a turbo chilling apparatus, and to provide a turbo chilling apparatus equipped with the turbo compressor.

### Solution to Problem

A turbo compressor according to a first aspect of the present invention is a turbo compressor for compressing a low pressure refrigerant used at a maximum pressure of less than 0.2 MPaG, the turbo compressor including: a rotary shaft; an electric motor coaxially disposed on an intermediate portion of the rotary shaft so as to rotationally drive the rotary shaft; an impeller fixed to one end of the rotary shaft and forming a compression portion; a first bearing pivotally supporting the rotary shaft between the electric motor and the impeller; and a second bearing pivotally supporting the other end of the rotary shaft, wherein one of the first bearing and the second bearing is formed of a rolling bearing, and the other of the first bearing and the second bearing is formed of a sliding bearing.

According to the turbo compressor having the above-mentioned configuration, one of the two bearings which support the rotary shaft is formed of the sliding bearing. The sliding bearing allows the movement of the rotary shaft in the axial direction. Accordingly, when the rotary shaft thermally elongates in the axial direction due to heat input from the electric motor, the rotary shaft moves in the axial direction in the sliding bearing so that the thermal elongation is absorbed.

The sliding bearing has an action where an oil film formed of a lubricant oil interposed between a journal portion of the rotary shaft and a bearing metal forms a shock absorber so that vibration of the rotary shaft is attenuated. Accordingly, the natural frequency of the rotary shaft can be increased (a Q value can be lowered). Therefore, it is possible to suppress the generation of rotational vibration of the rotary shaft.

As described above, the thermal elongation of the rotary shaft can be absorbed and, at the same time, the rotational vibration of the rotary shaft can be suppressed. Accordingly, a mechanical loss can be lowered thus enhancing the efficiency of the turbo chilling apparatus.

In the turbo compressor having the above-mentioned configuration, it is preferable that the first bearing be formed of the rolling bearing, and the second bearing be formed of the sliding bearing.

The first bearing disposed on the side of the impeller forming the compression portion is formed of the rolling bearing. Accordingly, when the rotary shaft thermally elongates, such thermal elongation is absorbed by the second bearing disposed at a position separated from the impeller so that the rotary shaft does not move in the axial direction in the first bearing disposed at a position close to the impeller.

With such a configuration, there is no concern of the impeller, where severe gap accuracy is required between the impeller and the casing, moving in the axial direction thus coming into contact with the casing. Accordingly, a narrow gap formed between the impeller and the casing can be maintained with high accuracy thus suppressing the lowering of the efficiency of the turbo compressor.

In the turbo compressor having the above-mentioned configuration, an outer diameter of a journal portion of the rotary shaft which is pivotally supported by the sliding bearing may be set larger than a basic outer diameter of the rotary shaft.

As described above, the outer diameter of the journal portion of the rotary shaft pivotally supported by the sliding bearing is set large and hence, an inner peripheral surface of the bearing metal and an outer peripheral surface of the journal portion opposedly face each other over large areas. Accordingly, it is possible to enhance the shock absorbing action provided by the oil film formed of the lubricant oil interposed between the bearing metal and the journal portion. For this reason, rotational vibration of the rotary shaft can be suppressed more effectively.

In the turbo compressor having the above-mentioned configuration, a viscosity range of a lubricant oil for lubricating the second bearing may be set to a range of a VG grade 100 or more and 220 or less.

By setting the viscosity range of the lubricant oil as described above, the shock absorbing action provided by the lubricant oil film can be enhanced in the sliding bearing and hence, rotational vibration of the rotary shaft can be suppressed more effectively.

A turbo chilling apparatus according to a second aspect of the present invention includes: the turbo compressor described in any one of the above-mentioned configurations for compressing a low pressure refrigerant used at a maximum pressure of less than 0.2 MPaG; a condenser for condensing the low pressure refrigerant compressed by the turbo compressor; and an evaporator for evaporating the expanded low pressure refrigerant.

According to the turbo chilling apparatus having the above-mentioned configuration, a mechanical loss in the turbo compressor caused by thermal elongation or rotational vibration of the rotary shaft can be suppressed thus enhancing the efficiency of the turbo chilling apparatus.

### Advantageous Effects of Invention

As has been described above, according to the turbo compressor and the turbo chilling apparatus equipped with the turbo compressor of the present invention, in the turbo compressor for compressing a low pressure refrigerant used at a maximum pressure of less than 0.2 MPaG, a mechanical loss caused by thermal elongation or rotational vibration of a rotary shaft can be suppressed thus enhancing the efficiency of the turbo chilling apparatus.

### BRIEF DESCRIPTION OF DRAWINGS

FIG. 1 An overall view of a turbo chilling apparatus according to an embodiment of the present invention.

FIG. 2 A longitudinal cross-sectional view of a turbo compressor taken along line II-II in FIG. 1.

### DESCRIPTION OF EMBODIMENTS

Hereinafter, an embodiment of the present invention is described with reference to drawings.

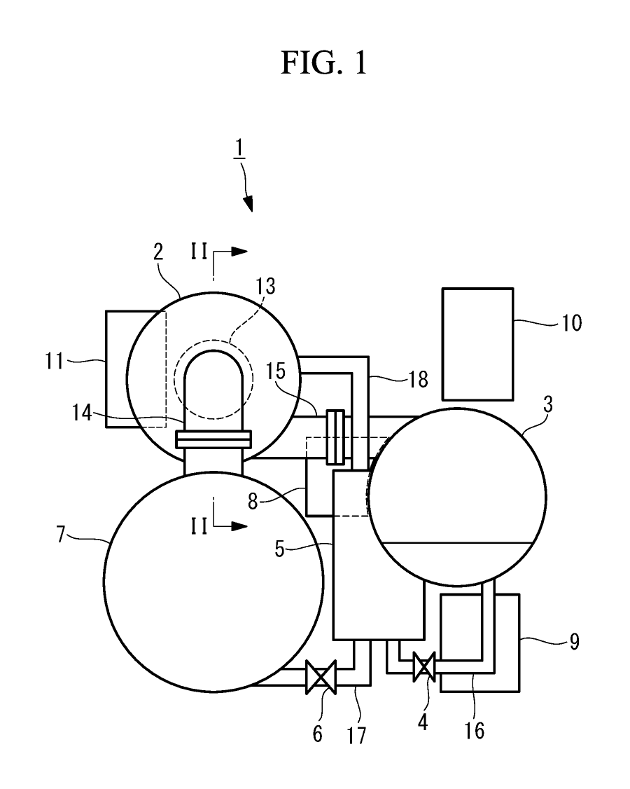

FIG. 1 is an overall view of a turbo chilling apparatus according to the embodiment of the present invention. The turbo chilling apparatus 1 includes: a turbo compressor 2 for compressing a refrigerant; a condenser 3; a high pressure expansion valve 4; an intermediate cooler 5; a low pressure expansion valve 6; an evaporator 7; a lubricant oil tank 8; a circuit box 9; an inverter unit 10; an operation panel 11. These members are formed into a unit. The lubricant oil tank 8 is a tank for storing a lubricant oil to be supplied to a bearing of the turbo compressor 2, a speed increaser and the like.

Each of the condenser 3 and the evaporator 7 is formed into a barrel shell shape having a high pressure resistance. The condenser 3 and the evaporator 7 are disposed adjacently and parallel to each other with the axes thereof extending in the substantially horizontal direction. The condenser 3 is disposed at a position relatively higher than the evaporator 7, and the circuit box 9 is disposed below the condenser 3. The intermediate cooler 5 and the lubricant oil tank 8 are disposed so as to be sandwiched between the condenser 3 and the evaporator 7. The inverter unit 10 is disposed above the condenser 3, and the operation panel 11 is disposed above the evaporator 7. The lubricant oil tank 8, the circuit box 9, the inverter unit 10, and the operation panel 11 are respectively disposed so as not to largely project from an entire profile of the turbo chilling apparatus 1 as viewed in a plan view.

The turbo compressor 2 is of a centrifugal turbine type which is rotationally drive by an electric motor 13. The turbo compressor 2 is disposed above the evaporator 7 with a posture where an axis of the turbo compressor 2 extends in the substantially horizontal direction. The electric motor 13 is driven by the inverter unit 10. As described later, the turbo compressor 2 compresses a refrigerant in a gas phase which is supplied from the evaporator 7 through a suction pipe 14. The refrigerant is used at a maximum pressure of less than 0.2 MPaG. A low pressure refrigerant having an extremely low GWP such as R1233zd (E), R1233zd (Z) or R1234ze (Z) is used as the refrigerant.

A discharge outlet of the turbo compressor 2 and an upper portion of the condenser 3 are connected with each other by way of a discharge pipe 15, and a bottom portion of the condenser 3 and a bottom portion of the intermediate cooler 5 are connected with each other by way of a refrigerant pipe 16. The bottom portion of the intermediate cooler 5 and the evaporator 7 are connected with each other by way of a refrigerant pipe 17, and an upper portion of the intermediate cooler 5 and an intermediate section of the turbo compressor 2 are connected with each other by way of a refrigerant pipe 18. The refrigerant pipe 16 is equipped with the high pressure expansion valve 4, and the refrigerant pipe 17 is equipped with the low pressure expansion valve 6.

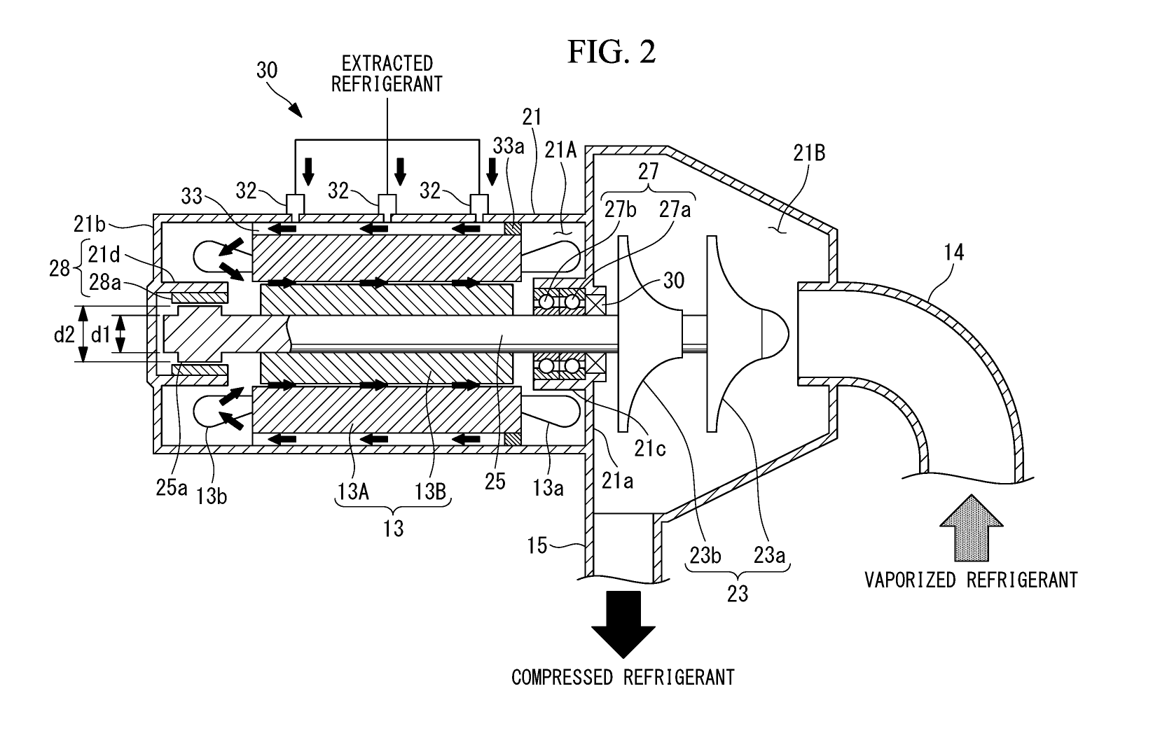

FIG. 2 is a longitudinal cross-sectional view of the turbo compressor taken along line II-II in FIG. 1.

The turbo compressor 2 includes: a casing 21 having a cylindrical shape with a stepped portion, the casing 21 forming an outer shell of the turbo compressor 2; the electric motor 13; a compression portion 23; a rotary shaft 25; a rolling bearing 27 (first bearing); a sliding bearing 28 (second bearing); and a refrigerant supply portion 30. The inside of the casing 21 is divided into an electric motor chamber 21A and a compression chamber 21B by a partition wall 21a. The electric motor 13 is accommodated in the electric motor chamber 21A, and the compression portion 23 is accommodated in the compression chamber 21B.

The rotary shaft 25 extends along a central axis of the casing 21 in the inside of the casing 21. The rotary shaft 25 is pivotally supported by the rolling bearing 27 disposed on the partition wall 21a of the casing 21, and by the sliding bearing 28 which is disposed on a side opposite to the partition wall 21a, and is disposed on an end wall surface 21b of the electric motor chamber 21A disposed on a depth side. One end of the rotary shaft 25 penetrates the partition wall 21a from the electric motor chamber 21A, and extends into the compression chamber 21B.

The rolling bearing 27 is configured such that, for example, two angular ball bearings 27a, 27b are press fitted in a bearing boss 21c formed on the partition wall 21a in a back-to-back manner. The rolling bearing 27 rotatably supports the rotary shaft 25. However, the rolling bearing 27 does not allow the movement of the rotary shaft 25 in the axial direction. The rolling bearing 27 may be of any type different to the angular ball bearings 27a, 27b provided that the rolling bearing 27 can prevent the movement of the rotary shaft 25 in the axial direction. An oil seal 30 is disposed on the compression chamber 21B side of the rolling bearing 27.

On the other hand, the sliding bearing 28 is configured such that a bearing metal 28a is press fitted in a bearing boss 21d formed on the end wall surface 21b. A journal portion 25a of the rotary shaft 25 pivotally supported by the sliding bearing 28 has an outer diameter d2 set larger than a basic outer diameter d1 of the rotary shaft 25.

The electric motor 13 is coaxially mounted on an intermediate portion of the rotary shaft 25, and rotationally drives the rotary shaft 25. The electric motor 13 includes: a stator 13A fixed to a peripheral wall surface in the electric motor chamber 21A; and a rotor 13B fixed to the rotary shaft 25 and rotating on the inner peripheral side of the stator 13A. Coil ends 13a, 13b project from both end portions of the stator 13A in the longitudinal axis direction.

Impellers 23a, 23b in two stages, for example, fixed to one end of the rotary shaft 25 form the compression portion 23 in cooperation with a compression path structure not shown in the drawing which is formed in the compression chamber 21B. The structure and manner of operation of the compression portion 23 are known so that the detailed illustration and the description of the compression portion 23 are omitted. The rolling bearing 27 pivotally supports the rotary shaft 25 between the electric motor 13 and the impellers 23a, 23b, and the other end of the rotary shaft 25 is pivotally supported by the sliding bearing 28.

The rolling bearing 27 and the sliding bearing 28 are lubricated by a lubricant oil stored in the lubricant oil tank 8 shown in FIG. 1. A viscosity range of the lubricant oil is set to a range of a VG grade 100 or more and 220 or less.

The refrigerant supply portion 30 extracts a portion of a condensed refrigerant in a liquid state, or a portion of a refrigerant in a gas-liquid two-phase state, and injects the extracted refrigerant into the casing 21 from one or more refrigerant nozzles 32 mounted on an outer peripheral surface of the casing 21 thus cooling the electric motor 13. The respective refrigerant nozzles 32 are disposed at a position adjacently to the stator 13A of the electric motor 13. A gap 33 is formed between the stator 13A and an inner peripheral surface of the casing 21. An end portion of the gap 33 on the compression portion 23 side is closed by a closure ring 33a. Alternatively, an opening area of the gap 33 on the compression portion 23 side is reduced.

The main portion of the refrigerant injected from the refrigerant nozzles 32 flows to the sliding bearing 28 side through the gap 33 thus cooling an outer peripheral side of the stator 13A and the coil end 13b. Thereafter, the refrigerant flows to the rolling bearing 27 side through a gap formed between the stator 13A and the rotor 13B thus cooling the inner peripheral side of the stator 13A and the rotor 13B. With such cooling, the electric motor 13 is uniformly cooled. The refrigerant used for cooling is returned to a refrigerant system through an exhaust port not shown in the drawing.

In the turbo chilling apparatus 1 equipped with the turbo compressor 2 having the above-mentioned configuration, when the compression portion 23 is driven by the electric motor 13 of the turbo compressor 2, a vaporized refrigerant is sucked into the compression portion 23 from the suction pipe 14, and is compressed. The compressed refrigerant is fed to the condenser 3 from the discharge pipe 15.

In the inside of the condenser 3, a low pressure refrigerant having a high temperature which is compressed by the turbo compressor 2 is subjected to heat exchange with cooling water so that heat of condensation is cooled thus being condensed and liquefied. The low pressure refrigerant formed into a liquid phase state in the condenser 3 passes through the high pressure expansion valve 4 disposed on the refrigerant pipe 16, and expands. Accordingly, the low pressure refrigerant is formed into a gas-liquid mixed state, and is fed to the intermediate cooler 5. The low pressure refrigerant is temporarily stored in the intermediate cooler 5.

In the inside of the intermediate cooler 5, the low pressure refrigerant, which expands in the high pressure expansion valve 4 thus being in a gas-liquid mixed state, is subjected to gas-liquid separation into a gas phase portion and a liquid phase portion. The liquid phase portion of the low pressure refrigerant separated in the intermediate cooler 5 further expands in the low pressure expansion valve 6 disposed on the refrigerant pipe 17 thus forming a gas-liquid two-phase flow. The gas-liquid two-phase flow is fed to the evaporator 7. The gas phase portion of the low pressure refrigerant separated in the intermediate cooler 5 is fed to an intermediate section portion of the turbo compressor 2 through the refrigerant pipe 18, and is compressed again.

In the inside of the evaporator 7, a liquid refrigerant having a low temperature which is subjected to adiabatic expansion in the low pressure expansion valve 6 is subjected to heat exchange with water. Chilled water which is cooled in the evaporator 7 is utilized as a cold refrigerant for air conditioning, cooling water for industrial use or the like. The refrigerant vaporized due to the heat exchange with water is sucked into the turbo compressor 2 again through the suction pipe 14, and is compressed. The above-mentioned cycle is repeated thereafter.

In the turbo compressor 2 according to this embodiment, one of two bearings which pivotally support the rotary shaft 25 is the rolling bearing 27, and the other of the two bearings is the sliding bearing 28. The sliding bearing 28 allows the movement of the rotary shaft 25 in the axial direction. Accordingly, when the rotary shaft 25 thermally elongates in the axial direction due to heat input from the electric motor 13, the rotary shaft 25 moves in the axial direction in the sliding bearing 28 so that the thermal elongation is absorbed.

In the sliding bearing 28, an oil film formed of a lubricant oil interposed between the journal portion 25a of the rotary shaft 25 and the bearing metal 28a forms a shock absorber so that vibration of the rotary shaft 25 is attenuated. Accordingly, the natural frequency of the rotary shaft 25 can be increased (a Q value can be lowered). Therefore, it is possible to suppress the generation of rotational vibration of the rotary shaft 25.

As described above, the thermal elongation of the rotary shaft 25 can be absorbed and, at the same time, the rotational vibration can be suppressed. Accordingly, even when a diameter of the impellers 23a, 23b of the compression portion 23 is increased so as to cope with a low pressure refrigerant such as HFO-1233zd (E), there is no possibility that a mechanical loss is increased thus lowering the efficiency of the turbo chilling apparatus 1.

In this embodiment, the bearing 27 which pivotally supports the rotary shaft 25 between the electric motor and the impellers 23a, 23b forming the compression portion 23 is formed of a rolling bearing. The bearing 28 which pivotally supports the other end of the rotary shaft 25 at a position separated from the impellers 23a, 23b by a distance is formed of a sliding bearing. As described above, the bearing 27 disposed on the side of the impellers 23a, 23b is formed of a rolling bearing so that the increase in mechanical loss can be suppressed. At the same time, when the rotary shaft 25 thermally elongates, such thermal elongation of the rotary shaft 25 is absorbed by the sliding bearing 28 disposed at a position separated from the impellers 23a, 23b by a distance and hence, the rotary shaft 25 does not move in the axial direction in the rolling bearing 27.

Accordingly, there is no concern of the impellers 23a, 23b, where severe gap accuracy is required between the impellers 23a, 23b and the casing 21 (compression chamber 21B), moving in the axial direction thus coming into contact with the casing 21. Accordingly, the narrow gap formed between the impellers 23a, 23b and the casing 21 can be maintained with high accuracy thus suppressing the lowering of the efficiency of the turbo compressor 2.

The outer diameter d2 of the journal portion 25a of the rotary shaft 25 pivotally supported by the sliding bearing 28 is set larger than the basic outer diameter d1 of the rotary shaft 25 and hence, an inner peripheral surface of the bearing metal 28a and an outer peripheral surface of the journal portion 25a opposedly face each other over large areas. Accordingly, it is possible to enhance the shock absorbing action provided by the oil film formed of the lubricant oil interposed between the bearing metal 28a and the journal portion 25a. For this reason, rotational vibration of the rotary shaft 25 can be suppressed more effectively.

Further, a viscosity range of the lubricant oil for lubricating the rolling bearing 27 and the sliding bearing 28 is set to a range of a VG grade 100 or more and 220 or less. Accordingly, particularly in the sliding bearing 28, the shock absorbing action provided by a lubricant oil film can be enhanced and hence, rotational vibration of the rotary shaft 25 can be suppressed more effectively. In the verification experiment performed by the inventors, compatible viscosity of a combination of HFO-1233zd (E) refrigerant and a mineral oil of VG100 could be enhanced by approximately 90% compared with a conventional POE oil having a VG grade 68.

As has been described heretofore, the turbo compressor 2 according to this embodiment adopts a structure where the turbo compressor 2 is not influenced by thermal elongation of the rotary shaft 25, and rotational vibration of the rotary shaft 25 can be suppressed thus suppressing a mechanical loss. Accordingly, in compressing a low pressure refrigerant used at a maximum pressure of less than 0.2 MPaG, a mechanical loss caused by thermal elongation or rotational vibration of the rotary shaft 25 can be suppressed thus enhancing the efficiency of the turbo chilling apparatus 1.

The present invention is not limited to the configuration of the above-mentioned embodiment, and modifications or improvements may be appropriately made thereto. Embodiments to which such modifications or improvements are made also fall within the scope of the present invention.

### REFERENCE SIGNS LIST

1 turbo chilling apparatus
2 turbo compressor
3 condenser
7 evaporator
13 electric motor
13A stator
13B rotor
13a, 13b coil end
21 casing
23 compression portion
23a, 23b impeller
25 rotary shaft
25a journal portion
27 rolling bearing (first bearing)
27a, 27b angular ball bearing
28 sliding bearing (second bearing)
28a bearing metal
30 refrigerant supply portion
32 refrigerant nozzle
d1 basic outer diameter of rotary shaft
d2 outer diameter of journal portion

1. A turbo compressor for compressing a low pressure refrigerant used at a maximum pressure of less than 0.2 MPaG, the turbo compressor comprising:
a rotary shaft;
an electric motor coaxially disposed on an intermediate portion of the rotary shaft so as to rotationally drive the rotary shaft;
an impeller fixed to one end of the rotary shaft and forming a compression portion;
a first bearing pivotally supporting the rotary shaft between the electric motor and the impeller; and
a second bearing pivotally supporting the other end of the rotary shaft, wherein
one of the first bearing and the second bearing is formed of a rolling bearing, and the other of the first bearing and the second bearing is formed of a sliding bearing.

2. The turbo compressor according to claim 1, wherein the first bearing is formed of the rolling bearing, and the second bearing is formed of the sliding bearing.

3. The turbo compressor according to claim 1, wherein an outer diameter of a journal portion of the rotary shaft which is pivotally supported by the sliding bearing is set larger than a basic outer diameter of the rotary shaft.

4. The turbo compressor according to claim 1, wherein a viscosity range of a lubricant oil for lubricating the second bearing is set to a range of a VG grade 100 or more and 220 or less.

5. A turbo chilling apparatus comprising:
the turbo compressor described in claim 1 for compressing a low pressure refrigerant used at a maximum pressure of less than 0.2 MPaG;
a condenser for condensing the low pressure refrigerant compressed by the turbo compressor; and
an evaporator for evaporating the expanded low pressure refrigerant.

6. The turbo compressor according to claim 2, wherein an outer diameter of a journal portion of the rotary shaft which is pivotally supported by the sliding bearing is set larger than a basic outer diameter of the rotary shaft.

7. The turbo compressor according to claim 2, wherein a viscosity range of a lubricant oil for lubricating the second bearing is set to a range of a VG grade 100 or more and 220 or less.

8. The turbo compressor according to claim 3, wherein a viscosity range of a lubricant oil for lubricating the second bearing is set to a range of a VG grade 100 or more and 220 or less.

9. A turbo chilling apparatus comprising:
the turbo compressor described in claim 2 for compressing a low pressure refrigerant used at a maximum pressure of less than 0.2 MPaG;
a condenser for condensing the low pressure refrigerant compressed by the turbo compressor; and
an evaporator for evaporating the expanded low pressure refrigerant.

10. A turbo chilling apparatus comprising:
the turbo compressor described in claim 3 for compressing a low pressure refrigerant used at a maximum pressure of less than 0.2 MPaG;
a condenser for condensing the low pressure refrigerant compressed by the turbo compressor; and
an evaporator for evaporating the expanded low pressure refrigerant.

11. A turbo chilling apparatus comprising:
the turbo compressor described in claim 4 for compressing a low pressure refrigerant used at a maximum pressure of less than 0.2 MPaG;
a condenser for condensing the low pressure refrigerant compressed by the turbo compressor; and
an evaporator for evaporating the expanded low pressure refrigerant.
